(19) United States
(12) Patent Application Publication
(10) Pub. No.: US 2015/0111110 A1
(43) Pub. Date: Apr. 23, 2015

(54) SOLID ELECTROLYTE AND SECONDARY BATTERY

(71) Applicant: KABUSHIKI KAISHA TOYOTA JIDOSHOKKI, Kariya-shi, Aichi (JP)

(72) Inventors: Nagisa Watanabe, Kariya-shi (JP); Kazuhito Kawasumi, Kariya-shi (JP); Junichi Niwa, Kariya-shi (JP); Masataka Nakanishi, Kariya-shi (JP)

(73) Assignee: KABUSHIKI KAISHA TOYOTA JIDOSHOKKI, Kariya-shi, Aichi (JP)

(21) Appl. No.: 14/396,775

(22) PCT Filed: Apr. 25, 2013
(86) PCT No.: PCT/JP2013/002815

§ 371 Date: Oct. 24, 2014

(30) Foreign Application Priority Data
Apr. 27, 2012 (JP) 2012-102275

(51) Int. Cl. H01M 10/0562

(52) U.S. Cl. CPC H01M 10/0562; H01M 2300/0071
USPC 429/304

(57) ABSTRACT

A solid electrolyte has a sheet shape, and is composed of an oxide sintered body. The solid electrolyte includes a layer-shaped dense portion whose sintered density is 90% or more, and a porous portion formed on a superficial side of the solid electrolyte so as to be continuous from at least one of opposite surfaces of the dense portion, and having a porosity of 50% or more. A secondary battery includes a positive electrode, and a negative electrode, the positive electrode and negative electrode arranged at opposite facing positions interposing the solid electrolyte.

### TECHNICAL FIELD

The present invention relates to a solid electrolyte, and to a secondary battery using the same.

### BACKGROUND ART

A lithium secondary battery using a lithium metal for the negative electrode has a large battery capacity per mass theoretically, and exhibits a high potential. Moreover, the lithium secondary battery does not require any conductive additive and current collector. Accordingly, the lithium secondary battery suffers less from troubles with the application of conductive additive and onto current collector. Consequently, the lithium secondary battery enables manufactures to lower costs.

However, when charging and discharging the lithium secondary battery repetitively, there possibly arises such a fear that lithium grows like a tree shape to form dendrites. Accordingly, there possibly arises such another fear that the dendrites penetrate through a separator to cause short-circuiting so that the battery becomes inoperable. Consequently, many of lithium-ion secondary batteries have been using carbonaceous materials for the negative electrode at present. In electrode components other than lithium, too, there also possibly arises such a fear that doing charging and discharging operations repetitively results in growing dendrites. When one of electrode components is made of lithium, however, dendrites are more likely to grow in the electrode component than in the electrode components.

Meanwhile, interposing a solid electrolyte between a positive electrode and a negative electrode to make an all-solid secondary battery leads to expecting the resulting secondary battery to exhibit an improved battery capacity. Moreover, since no organic solvent is used, the safeness upgrades.

In all-solid secondary batteries, using a solid electrolyte composed of an oxide sintered body has been proposed. Since the solid sintered body is hard, dendrites are prevented from penetrating through the solid electrolyte. However, since an interface resistance is high between the solid electrolyte and an electrode material, the solid electrolyte results in low battery performance. A reason for the high interface resistance between the solid electrolyte and an electrode material is that, since the two are solids one another, the contact between the two becomes a point contact so that ion-conductive paths arise less.

Hence, a solid electrolyte resisting the formation of dendrites and exhibiting a reduced interface resistance has been needed. Japanese Unexamined Patent Publication (KOKAI) Gazette No. 2010-218686, and Japanese Unexamined Patent Publication (KOKAI) Gazette No. 2009-238739 disclose, respectively, an all-solid secondary battery comprising a solid electrolyte, which is composed of an oxide sintered body and whose superficial part is turned into being porous.

Moreover, the solid electrolyte is also employed in an electrolytic-solution secondary battery using a water-based or non-water-based electrolytic solution. The solid electrolyte is herein used as a separator demarcating between the opposite electrodes. Even in the solid electrolyte used as a separator in an electrolytic-solution secondary battery, a solid electrolyte composed of a hard oxide sintered body and provided with irregularities on the surface has been developed, as disclosed in Japanese Unexamined Patent Publication (KOKAI) Gazette No. 2010-108809. Even in the electrolytic-solution secondary battery, charging and discharging the electrolytic-solution secondary battery repetitively results in growing dendrites of the electrode components. The hard solid electrolyte, which Japanese Unexamined Patent Publication (KOKAI) Gazette No. 2010-108809 discloses and serves as a separator, is also suppressed from being penetrated by dendrites.

### RELATED ART

Patent Application Publication No. 1: Japanese Unexamined Patent Publication (KOKAI) Gazette No. 2010-218686;

Patent Application Publication No. 2: Japanese Unexamined Patent Publication (KOKAI) Gazette No. 2009-238739; and

Patent Application Publication No. 3: Japanese Unexamined Patent Publication (KOKAI) Gazette No. 2010-108809

### SUMMARY OF THE INVENTION

### Problems to be Solved by the Invention

In accordance with the solid electrolytes used in all-solid secondary batteries disclosed in Japanese Unexamined Patent Publication (KOKAI) No. 2010-218686 and Japanese Unexamined Patent Publication (KOKAI) No. 2009-238739, however, a particle-shaped polymeric material is used as a pore-making agent when the porous portion is formed. The particle-shaped polymeric material is deposited on a substrate, and the substrate is then dipped into a solution in which solid-electrolyte fine particles have been dispersed in a solvent. Under the circumstances, an obtainable porosity is limited to 70% even when the pore-making agent is packed closely, and accordingly no porous portion exhibiting a porosity of more than 70% is formed. When a solid electrolyte has a small porosity, ion conductors are less likely to go deep down into the inside of the solid electrolyte, so that the solid electrolyte exhibits a poor ion-conducting efficiency.

In accordance with the separator used for the all-solid secondary battery disclosed in Japanese Unexamined Patent Publication (KOKAI) No. 2010-108809, irregularities are formed only on the surface of a solid electrolyte. Consequently, the contact area between the solid electrolyte and an electrode material is increased to a low extent, so that demonstrating practical battery performance is difficult.

The present invention is made in view of such circumstances. An object of the present invention is to provide the following: a solid electrolyte prevented from being penetrated by dendrites of electrode components, and having a high ion-conductive property; and a secondary battery using the same.

### Means for Achieving the Object

(1) A solid electrolyte according to the present invention is a sheet-shaped solid electrolyte composed of an oxide sintered body, and comprises:

a layer-shaped dense portion whose sintered density is 90% or more; and
a porous portion formed on a superficial side of said solid electrolyte so as to be continuous from at least one of opposite surfaces of said dense portion, and having a porosity of 50% or more.

(2) A secondary battery according to the present invention comprises:

the solid electrolyte as set forth above;
a positive electrode; and
a negative electrode;
the positive electrode and negative electrode arranged at opposite facing positions interposing said solid electrolyte.

(3) Another secondary battery according to the present invention comprises:

a separator composed of the solid electrolyte as set forth above;
a positive electrode;
a negative electrode;
the positive electrode and negative electrode arranged at opposite facing positions interposing said separator; and
an electrolytic solution filling up at least one of opposite sides interposing said separator, the opposite sides including a positive-electrode side on which said positive electrode is arranged, and a negative-electrode side on which said negative electrode is arranged.

### Advantages of the Invention

The solid electrolyte according to the present invention is composed of an oxide sintered body. Moreover, the present solid electrolyte comprises a dense portion having the predetermined sintered density as aforementioned, and a porous portion exhibiting the predetermined porosity as aforementioned. Consequently, the following are provided: a solid electrolyte prevented from being penetrated by dendrites of electrode components, and having a high ion-conductive property; and a secondary battery using the same.

### BRIEF DESCRIPTION OF THE DRAWINGS

FIG. 1 is a cross-sectional explanatory diagram of a solid electrolyte according to First Embodiment of the present invention;

FIG. 2 is a cross-sectional explanatory diagram of a solid electrolyte according to Second Embodiment;

FIG. 3 is a cross-sectional explanatory diagram of a solid electrolyte according to Third Embodiment;

FIG. 4 is a cross-sectional explanatory diagram of a solid electrolyte according to Fourth Embodiment;

FIG. 5 is a cross-sectional explanatory diagram of a solid electrolyte according to Fifth Embodiment;

FIG. 6 is a cross-sectional explanatory diagram of a solid electrolyte according to Sixth Embodiment;

FIG. 7 is a cross-sectional explanatory diagram of a solid electrolyte according to Reference Example;

FIG. 8 is a cross-sectional explanatory diagram of First Battery;

FIG. 9 is a cross-sectional explanatory diagram of First Comparative Battery; and

FIG. 10 is a cross-sectional explanatory diagram of Third Battery.

### DETAILED DESCRIPTION OF THE PREFERRED EMBODIMENTS

A solid electrolyte and secondary battery directed to embodiment modes according to the present invention are hereinafter described in detail.

### (Solid Electrolyte)

Since a solid electrolyte exhibits an ion-conductive property, the solid electrolyte demonstrates the ion-conductive property between a positive electrode and a negative electrode when being arranged between the positive electrode and the negative electrode.

The solid electrolyte is composed of an oxide sintered body. The oxide sintered body is hard, compared with a solid electrolyte composed of an organic polymeric material. Consequently, even when dendrites of electrode components have grown, the solid electrolyte is inhibited from being penetrated by the dendrites. Hence, no fear of short-circuiting arises. Moreover, since the oxide sintered body has high water resistance, the oxide sintered body is also usable as a separator for water-based electrolytic solution. Since the oxide sintered body has high heat resistance, the oxide sintered body is so less likely to burn to be safe. The oxide sintered body is thus employable stably even under severe environmental conditions.

The solid electrolyte comprises a dense portion, and a porous portion formed on a superficial side of the solid electrolyte so as to be continuous from at least one of opposite surfaces of the dense portion. The dense port ion extends in a perpendicular direction to a migration direction of ion, and thereby blocking dendrites of electrode components from penetrating through the dense portion itself. An allowable cross section of the dense portion has a planar configuration. Moreover, a permissible cross section of the dense portion takes on a configuration in which irregularities are repeated. A preferable cross section of the dense portion takes on a configuration in which irregularities are repeated while retaining an identical thickness. For example, following configurations are available: a configuration in which zigzag-shaped irregularities are repeated in a planar direction on both of the front and rear faces of the dense portion while retaining an identical thickness; or another configuration in which wave-shaped irregularities are repeated in a planar direction on both of the front and rear faces of the dense portion while retaining an identical thickness, and so on.

The dense portion has a sintered density of 90% or more. Consequently, the dense portion blocks substances from migrating between the front face and the rear face, while exhibiting an ion-conductive property. Thus, when the solid electrolyte is arranged between a positive electrode and a negative electrode, the solid electrolyte blocks substances other than ions from migrating between the positive electrode and the negative electrode, thereby preventing short-circuiting from occurring. Moreover, the dense portion prevents dendrites of electrode components from penetrating through the solid electrolyte. On the other hand, when the dense portion has a sintered density of less than 90%, there possibly arises such a fear that substances other than ions pass through the dense portion, and thereby resulting in a case where the property of blocking the substances from migrating possibly declines at the dense portion.

In addition, a preferable lower limit of the sintered density of the dense portion is 95%, or a more preferable lower limit thereof is 97%. Under the conditions, the blocking property of the dense portion upgrades further. Although a preferable upper limit of the sintered density of the dense portion is as close as possible to 100% from the viewpoint of the blocking property, an acceptable upper limit thereof is 95% from the viewpoint of mass-producibility. The “sintered density of the dense portion” refers to a rate (or percentage) of a density of the dense portion to the true density of the dense portion.

An allowable open porosity of the dense portion is 5% or less, or a more allowable open porosity thereof is 3% or less. Under the conditions, substances other than ions are inhibited effectively from migrating between the front and rear of the dense portion. The “open porosity of the dense portion” refers to a rate (or percentage) of a summed volume of open pores inside the dense portion to the entire volume of the dense portion. The “open pores inside the dense portion” refer to pores not only formed in the dense portion but also communicating with the exterior of the dense portion.

A preferable thickness of the dense portion is from 1 μm or more to 1,000 μm or less, or a more preferable thickness thereof is from 10 μm or more to 100 μm or less. Under the conditions, a rate of ionic conduction is made faster while preventing dendrites of electrode components from penetrating through the solid electrolyte, thereby enlarging the resulting battery capacity.

A preferable rate of the thickness of the dense portion to the overall thickness of the solid electrolyte is from 5% or more to 95% or less, or a more preferable rate thereof is from 10% or more to 90% or less. Under the conditions, the thickness of the dense portion is made thinner while keeping a thickness of the porous portion sufficiently. Consequently, a rate of ionic conduction is made faster, thereby enlarging the resulting battery outputs.

An allowable porous portion is formed on one of opposite faces of the front face and rear face of the dense portion. Moreover, a permissible porous portion is formed on both of the front and rear faces of the dense portion. When the porous portion is formed on both of the front and rear faces of the dense portion, the porous portions acceptably have thicknesses differing one another on both of the front and rear faces, respectively.

The porous portion is provided with a large number of pores. A porosity of the porous portion is 50% or more. The pores in the porous portion are able to make ion-conductive paths. A porosity of the porous portion being 50% or more results in forming a large number of pores in the porous portion, and thereby ion-conductive paths are made abundantly. Hence, the resulting battery capacity is enlarged. On the other hand, when a porosity of the porous portion is less than 50%, there possibly arises such a fear that the resultant battery capacity declines.

In addition, a preferable lower limit of the porosity of the porous portion is 70%, or a more preferable lower limit thereof is 80%. Under the conditions, ion-conductive paths are made in much larger numbers, and thereby the resulting battery capacity is enlarged more.

From the view point of retaining the porous portion in strength, a preferable upper limit of the porosity of the porous portion is 95%, or a more preferable upper limit thereof is 90%. The “porosity of the porous portion” refers to a rate of a summed volume of all pores formed in the porous portion to the entire volume of the porous portion. The “all pores” involve not only open pores opened to the exterior of the porous portion, but also involve closed pores closed in the interior of the porous portion but not opened to the exterior.

Note herein that a preferable porous portion comprises open pores opened to the exterior of the porous portion. An especially preferable porous portion has an open porosity of 50% or more. The “open porosity of the porous portion” refers to a rate of a summed volume of open pores, which are opened to the exterior of the porous portion, to the entire volume of the porous portion. If an open porosity of the porous portion is 50% or more, not only ion-conductive paths increase, but also an electrode active material becomes likely to enter the porous portion, when the electrode active material is applied onto the porous portion on the surface. Consequently, a contact area between the solid electrolyte and the electrode active material enlarges, and thereby the resulting battery capacity heightens more. Moreover, in an electrolytic-solution secondary battery, the electrolytic solution becomes likely to infiltrate into the open pores. Accordingly, the opportunity of contact between the electrolytic solution and the solid electrolyte augments. Consequently, ions become likely to be sorbed (or occluded) and desorbed (or released). Therefore, the resulting battery capacity upgrades more.

Moreover, a preferable lower limit of the open porosity of the porous portion is 60%, or a more preferable lower limit thereof is 70%. Under the conditions, the resulting battery capacity heightens much more.

From the viewpoint of retaining the porous portion in strength, a preferable upper limit of the open porosity of the porous portion is 95%, or a more preferable upper limit thereof is 90%.

An allowable rate of the open porosity of the porous portion to the porosity thereof is from 60% or more to 100% or less. Amore allowable rate of the open porosity to the porosity is from 70% or more to 100% or less, or furthermore from 80% or more to 100% or less. Under the conditions, many of the pores formed in the porous portion turn into open pores. Consequently, when an electrode active material is applied onto the porous portion on the surface, the electrode active material becomes likely to enter the porous portion, and thereby a contact area between the solid electrolyte and the electrode active material enlarges more. Moreover, in an electrolytic-solution secondary battery, the electrolytic solution becomes likely to infiltrate into the porous portion, and thereby ions become likely to be sorbed therein and desorbed therefrom. Hence, the resulting battery capacity increases more.

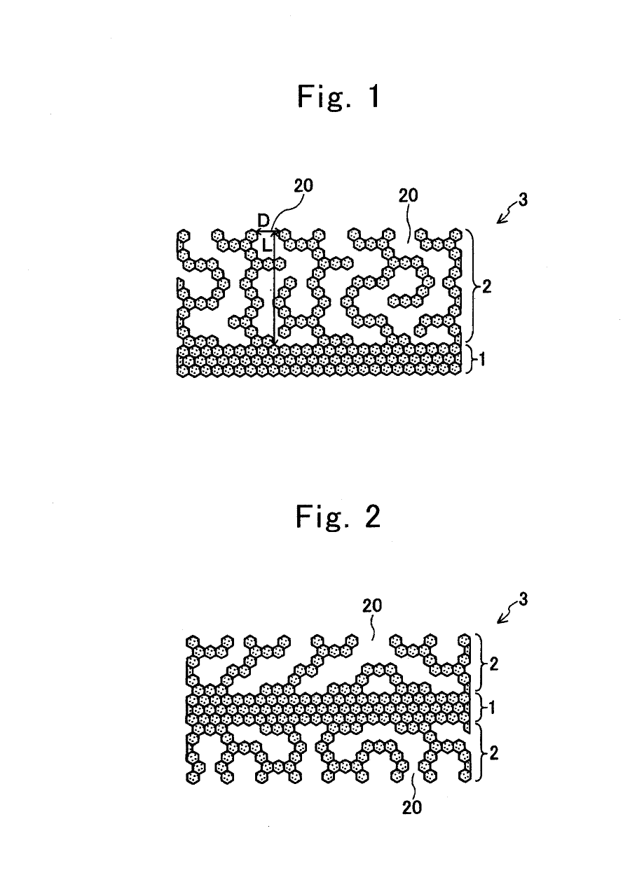

A preferable average depth “L” (see FIG. 1) of the open pores of the porous portion is from 0.1 μm or more to 500 μm or less, or a more preferable average depth “L” is from 1 μm or more to 100 μm or less. The “average depth ‘L’” refers to an average value of thickness-wise lengths from the opening end of the open pores opened to the exterior of the porous potion to the bottom of the open pores. If open pores are deep, an electrode active material enters the interior of the open pores when the electrode active material is applied onto the porous portion on the surface, and thereby a contact area between the solid electrolyte and the electrode active material increases. Moreover, in an electrolytic-solution secondary battery, the electrolytic solution permeates deep down into the interior of the porous portion quickly, and thereby ions become likely to be sorbed therein and desorbed therefrom and additionally an ion-conducting rate also becomes fast.

A desirable average opening diameter “D” (see FIG. 1) of the open pores of the porous portion is from 0.1 μm or more to 100 μm or less, or a more desirable average open diameter “D” is from 1 μm or more to 50 μm or less. The “average opening diameter ‘D’” refers to an average value of diameters of the maximum true circles fittable in the opening end of the open pores opened to the exterior of the porous potion. Under the conditions, an electrode active material is likely to enter the interior of the porous portion when the electrode active material is applied onto the porous portion on the surface, and a contact area between the solid electrolyte and the electrode active material is enlarged accordingly. Moreover, in an electrolytic-solution secondary battery, a permeation rate of the electrolytic solution into the interior of the porous portion quickens.

An allowable porosity of the porous portion is not only constant in the thickness-wise direction, but also varies in the thickness-wise direction. A permissible porosity of a superficial-layer section in the porous portion is larger than a porosity of an inner-side section in the porous portion. The “superficial-layer section in the porous portion” refers to a superficial-layer section, which is present on an opposite side to the dense portion, in the porous portion, whereas the “inner-side section in the porous portion” refers to an inner-side section, which is adjacent to the dense portion, in the porous portion. An allowable open porosity of the porous portion is not only constant in the thickness-wise direction, but also varies in the thickness-wise direction. A permissible open porosity of the superficial-layer section in the porous portion is larger than an open porosity of the inner-side section in the porous portion. Under the conditions, an electrode active material becomes likely to enter the inner-side section in the porous portion through the superficial-layer section, and thereby a contact area between the solid electrolyte and the electrode active material enlarges more. Moreover, in an electrolytic-solution secondary battery, the electrolytic solution becomes likely to infiltrate into the interior of the porous portion.

A preferable thickness of the porous portion is from 0.1 μm or more to 500 μm or less. Moreover, a desirable thickness of the porous portion is from 1 μm or more to 100 m or less. Under the conditions, since a contact area between the solid electrolyte and an electrode active material is enlarged sufficiently while thinning down the thickness of the solid electrolyte, a contact resistance exerted between the solid electrolyte and the electrode active material is reduced considerably. Moreover, in an electrolytic-solution secondary battery, since the opportunity of contact between the electrolytic solution and the solid electrolyte augments, ions become likely to be sorbed in the solid electrolyte and desorbed therefrom.

A preferable rate of the thickness of the porous portion to the thickness of the dense portion exceeds 0.1, but does not exceed 5. Under the conditions, the thickness of the dense portion, and the thickness of the porous portion are well balanced. Accordingly, dendrites of electrode components are securely prevented from penetrating through the solid electrolyte at the dense portion and many ion-conductive paths are formed at the porous portion so that a battery capacity is increased and producing a high-power output is intended. Note herein that, when the porous portion is formed on one of the opposite faces of the dense portion alone, the “thickness of the porous portion” refers to the thickness of the porous portion formed on one of the opposite faces of the dense portion. When the porous portion is formed on both of the front and rear faces of the dense portion, the “thickness of the porous portion” refers to the thickness of each of the porous portions.

An allowable overall thickness of the solid electrolyte is 2,000 μm or less. Amore allowable overall thickness of the solid electrolyte is 1,000 μm or less. A much more allowable overall thickness of the solid electrolyte is 400 μm or less. The most allowable overall thickness of the solid electrolyte is 100 μm or less. Under the conditions, downsizing a battery is intended. Moreover, a permissible lower limit of the overall thickness of the solid electrolyte is 50 μm. Amore permissible lower limit of the overall thickness is 20 μm. A much more permissible lower limit of the overall thickness is 10 μm. Under the conditions, a great number of ion-conductive paths are secured at the porous portion, and moreover dendrites are effectively prevented from penetrating through the solid electrolyte at the dense portion. When the overall thickness of the solid electrolyte becomes less than 10 μm, handling the solid electrolyte becomes difficult (i.e., poor handleability). Moreover, an active material is filled up in a less amount in the porous portion, and thereby there possibly arises such a fear that the resulting capacity lessens.

The oxide sintered body composing the solid electrolyte comprises such a crystal structure as a garnet-type crystal structure, a perovskite-type crystal structure, a NASICON-type crystal structure, a β″-Al₂O₃ type crystal structure or a β′-Al₂O₃ type crystal structure, for instance. Among the crystal structures, an especially preferable oxide sintered body has a garnet-type crystal structure.

An allowable crystal structure used for the oxide sintered body is the following, for instance: garnet-type Li₇La₃Zr₂O₁₂ (or LLZ) garnet-type Li₅La₃ (Nb, Ta)₂O₁₂, garnet-type Li₆BaLa₂Ta₂O₁₂, perovskite-type LiₓLa_{(2-(x/3))}TiO₃ (or LLT) (where 0<“x”<0.5), NASICON-type Li_{(1+x+y)}(Al, Ga)ₓ(Ti, Ge, Zr)₍₂₋ₓ₎Si_{y}P_{(3-y)}O₁₂ (where 0≦“x”<2, 0≦“y”<3, the Ti-based NASICON type refers to “LATP,” and the Ge-based NASICON type refers to “LAGP”) , β″-Al₂O₃ type Li₂O—5Al₂O₃, β′-Al₂O₃ type Li₂O-11Al₂O₃, or Li₄SiO₄. An especially permissible crystal structure is LAGP, garnet-type LLZ, garnet-type Li₅La₃(Nb,Ta)₂O₁₂, or garnet-type Li₆BaLa₂Ta₂O₁₂. The crystal structures are acceptable especially, because the crystal structures exhibit high ionic conductivity at room temperature, react hardly at the potential of Li, for instance, and exhibit high electrochemical stability.

Next, a production process for the solid electrolyte is hereinafter described. First, in order to produce the solid electrolyte, a solid-electrolyte powder composed of the solid electrolyte is synthesized by a solid phase method, a coprecipitation method, a hydrothermal method, a glass crystallization method, or a sol-gel method, and the like, for instance. The dense portion, and the porous portion are formed using the solid-electrolyte powder.

(1) For forming the dense portion, the following two methods are given as itemized (1-1) and (1-2) below, for instance.

(1-1) The solid-electrolyte powder is turned into a slurry with an organic solvent or water. Adding a binder further to the solid-electrolyte powder is also allowable, if needed. The slurry is formed as a desired configuration by using a doctor blade or roll coater, or by carrying out screen printing or cast molding. After the forming, the resulting formed body is dried, and is then sintered. Prior to sintering the formed body, the formed body is even permitted to undergo pressurizing by a cold isostatic-pressure forming method (or CIP), a warm isostatic-pressure forming method (or WIP), or a hot pressing method. When sintering the formed body, doing the following is acceptable: a hot isostatic-pressure forming method (or HIP); or sintering the formed body under a vacuum condition. The operations enhance the sintered density of the resultant dense portion, and thereby the porosity of the dense portion is declined.

(1-2) The solid-electrolyte powder is formed in such a configuration as a pellet or sheet by a hand press, and so on. Adding a binder further to the solid-electrolyte powder is also allowable, if needed. The resulting formed body is sintered. Prior to sintering the formed body, carrying out a CIP, WIP or hot pressing to the formed body is even permissible. At the time of the sintering, doing the following is acceptable: sintering the formed body while gripping the formed body with a setter made of quartz glass, and the like; performing an HIP or spark plasma sintering (or SPS) method; or sintering the formed body under a vacuum condition. The operations heighten the sintered density of the resultant dense portion.

Even in any of cases (1-1) and (1-2) above, the dense portion is formed as a desired configuration, such as a flat plane or irregular plane, by providing some of the surfaces of a casting mold, pressing mold or application substrate with a configuration corresponding to the desired configuration of the dense portion.

(2) For forming the porous portion, the dense portion is used as a substrate, and the porous portion is formed onto one of the opposite faces of the dense portion, or both of the opposite faces, by any one of the following methods as itemized (2-1) through (2-13) below.

(2-1) A slurry is made by adding water or an organic solvent to the solid-electrolyte powder. Adding a binder to the slurry is also acceptable. Beads composed of a polymeric material are turned into a casting mold, and then the slurry is poured into spaces between the beads to cast. The resulting cast workpiece is calcined and the beads are removed, thereby forming pores simultaneously with calcining the solid electrolyte.

(2-2) The solid-electrolyte powder is mixed into an organic material curing to a foamed configuration, such as foamed polystyrene, foamed polyurethane or baked carmelo (or nutless brittle), for instance, or into a precursor of the organic material curing to the foamed configuration. The resulting mixture is heated to undergo foaming. Thereafter, the resulting foamed body is sintered, and then organic substances are removed. Thus, pores are formed, and simultaneously therewith the solid electrolyte is sintered.

(2-3) A slurry is made by adding water or an organic solvent to the solid-electrolyte powder. Adding a binder to the slurry is also acceptable. The slurry is formed, and is then freeze dried. The freeze drying turns liquids within the slurry into frozen bodies in which the liquids are put in a state of being agglomerated one another. Drying the frozen bodies forms pores at locations where the frozen bodies have been existed. In accordance with the freeze-drying method, perpendicularly-long open pores extending in the thickness-wise direction of the porous portion are likely to be formed. The post-freeze-drying formed body is calcined, thereby calcining the solid electrolyte.

Note herein that adjusting conditions for freeze drying the formed body enables the resulting porosity to be provided with a gradient in the thickness-wise direction of the porous portion, or to maintain the porosity at a constant value in the thickness-wise direction. When the freeze-drying operation is carried out quickly in a short period of time, the porous portion with a constant porosity in the thickness-wise direction is formed. When the freeze-drying operation is carried out slowly while taking a lot of time, the resultant porosity is large in the superficial-layer section of the porous portion but is small in the interior of the porous portion.

(2-4) The solid electrolyte is readied by a sol-gel method. Hydrolyzing the prepared solid electrolyte with a basic substance leads to forming micrometer-size pores. Thereafter, the hydrolyzed solid electrolyte is dried to remove by-products, such as water and organic solvents, and is then calcined.

(2-5) A slurry is made by adding water or an organic solvent to the solid-electrolyte powder. Adding a binder to the slurry is also acceptable. A sponge, or a porous resinous body having been used for a separator for battery, is impregnated with the slurry, is dried, and is then sintered. Thus, the porous resinous body is removed, and thereby pores are formed among the solid electrolyte. In many cases, diameters of the resulting pores become as slightly large as a few dozen micrometers or more.

(2-6) The solid electrolyte is formed as a thick film by a sol-gel method. Carrying out the film forming by dipping or spinning is allowable. Moreover, not carrying out a heat treatment for every time after a single film-forming operation has been carried out, but the following is permissible: forming the resulting gelled solid electrolyte as a thick film by carrying out a heat treatment after doing the film-forming operation repetitively to turn the gelled solid electrolyte into the thick film. The gelled solid electrolyte formed as a film is freeze dried, and is thereafter sintered.

Note herein that adjusting conditions for freeze drying the formed film enables the resulting porosity to be provided with a gradient in the thickness-wise direction of the porous portion, or to maintain the porosity at a constant value in the thickness-wise direction. When the freeze-drying operation is carried out quickly in a short period of time, the porous portion with a constant porosity in the thickness-wise direction is formed. When the freeze-drying operation is carried out slowly while taking a lot of time, the resultant porosity is large in the superficial-layer section of the porous portion but is small in the interior of the porous portion.

(2-7) A kneaded substance in which the solid electrolyte and an ultraviolet curable resin have been mixed one another to harden is formed as a sheet shape on a surface of the dense portion. When making a drawing on the sheet-shaped kneaded substance by lithography and then carrying out etching, only irradiated sections having been irradiated with a light by lithography remain. Thereafter, the solid electrolyte is sintered.

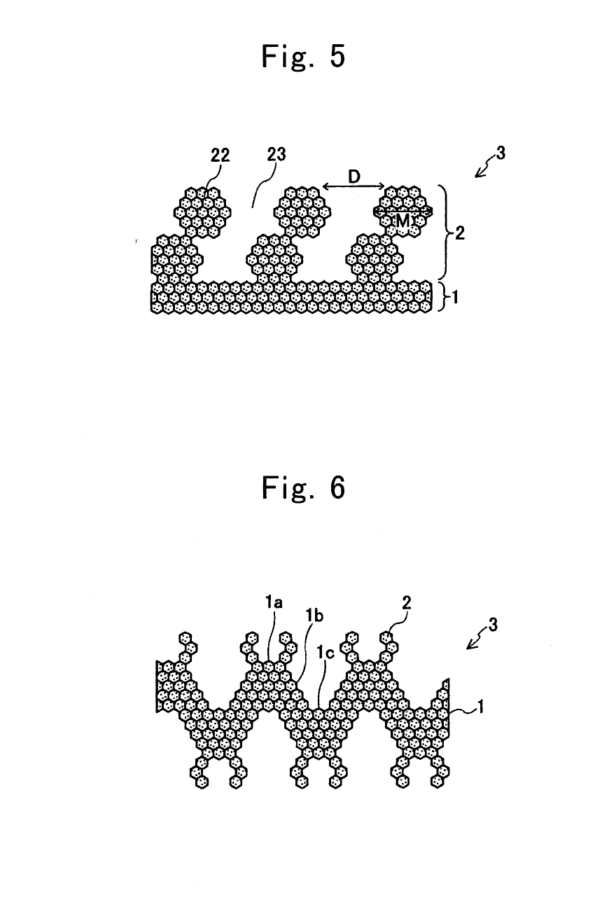

(2-8) The porous portion is formed by mixing particles of the solid-electrolyte powder and an electrode active material one another, coating the resulting mixture onto a surface of the dense portion and then calcining the coated mixture. Thus, the porous portion comprises the electrode active material, and the particles of the solid-electrolyte powder dispersed among the electrode active material. Forming a virtually porous solid-electrolyte layer by providing a predetermined space between the respective particles and making the electrode active material contain between the particles is allowable. Depositing a plurality of the particles of the solid-electrolyte powder one after another in the thickness-wise direction of the solid electrolyte is permissible. A preferable diameter “M” (see FIG. 5) of the particles of the solid-electrolyte powder is from 0.1 μm or more to 20 μm or less. Moreover, a preferable average opening diameter “D” of spaces between the particles of the solid-electrolyte powder is from 1 μm or more to 25 μm or less.

(2-9) The dense portion, and the porous portion are molded respectively and are then sintered while superimposing the two one another, and thereby the solid electrolyte is also formed. The molding of the dense portion and porous portion is done by carrying out pressing, doctor-blade coating, roll-coater coating or screen printing, and the like. After molding the dense portion and porous portion and superimposing the two one another, enhancing the adhesiveness between the two by doing various pressing operations, such as CIP, WIP or hot pressing, or employing an adhesive agent, such as a binder, is also acceptable.

When forming the porous portion having a gradient in the porosity in the thickness-wise direction, one of the following methods as itemized (2-10) through (2-13) below is carried out, for instance.

(2-10) A slurry is made by adding water or an organic solvent to the solid-electrolyte powder. Adding a binder to the slurry is also acceptable. The slurry is molded with a porous casting mold. The resulting molded body is dried through pores in the casting mold. When drying the molded body, drying conditions are adjusted so as to give a gradient to a water-content rate of the half-dried molded body in the thickness-wise direction. The molded body is cooled starting at one of the sides with a large water-content rate, and is then freeze dried. Thus, a gradient is given to the porosity of the molded body. Thereafter, the molded body is sintered to form a porous portion whose porosity has been provided with a gradient.

(2-11) A slurry of the solid-electrolyte powder is molded with a dense casting mold. The resulting molded body is dried on one of the opposite faces alone, thereby giving a gradient to the water-content rate. The molded body is cooled starting at one of the opposite sides with a large water-content rate, and is then freeze dried. Thus, the porosity of the molded body is provided with a gradient. The molded body is then sintered to form a porous portion whose porosity has been provided with a gradient.

(2-12) Polymeric microbeads are mixed with a slurry of the solid electrolyte. The resulting mixture is molded by a doctor-blade, roll-coater or screen-printing method, etc., and is then dried. Repeating the application of the microbeads while changing the mixing proportion or particle diameter, the porosity of the resultant molded body is provided with a gradient. Thereafter, the molded body is sintered, thereby forming the porous portion having a porosity to which a gradient is given.

(2-13) Polymeric microbeads are mixed with a slurry of the solid electrolyte. The resulting mixture is molded by a doctor-blade, roll-coater or screen-printing method, etc., and is then dried. Sheets, in which the mixing proportion or particle diameter of the microbeads has been altered one another, are molded in a quantity of two or more pieces. The sheets are superimposed one another, and are then integrated by a CIP method, and the like. The thus integrated product is sintered, thereby forming the porous portion with a porosity having a gradient.

A porosity is found, for example, by observing a cross section (or a fractured face, a CIP-processed face, and so on) with a scanning electron microscope (or SEM), and the like. An open porosity is computed, for example, from a bulk density and a sintered density found by an Archimedes method, and so forth.

### (Secondary Battery)

An ion conductor for a secondary battery using the aforementioned solid electrolyte is lithium ions, for instance. In a secondary battery in which lithium ions are an ion conductor, the “secondary battery” refers to a lithium secondary battery when the negative electrode is composed of a lithium metal or lithium alloy, whereas the “secondary battery” refers to a lithium-ion secondary battery when the negative electrode is composed of a negative-electrode material other than the lithium metal or lithium alloy.

For example, the following area secondary battery, respectively: a lithium secondary battery whose negative electrode is composed of lithium; an Li/Air battery whose negative electrode is lithium and positive electrode is oxygen; and an Li/Water battery whose negative electrode is lithium and positive electrode is water. In the batteries, lithium dendrites are likely to generate in a negative-electrode surface. Not only when using a lithium negative electrode, but also when using a negative electrode made of a carbonaceous material or a lithium-containing compound, or tin or silicon and an alloy of tin or silicon, and the like, there possibly arises a fear of generating dendrites because of overdischarge or gaps in the balance between positive and negative electrodes. Even a commonly-used lithium-ion secondary battery, in which a lithium-containing transition-metal oxide system makes the positive electrode and carbon makes the negative electrode, possibly suffers from the formation of dendrites. Since dendrites hardly penetrate through the solid electrolyte, there arises no fear of the occurrence of short-circuiting.

As for a secondary battery using the aforementioned solid electrolyte, the following are given, for instance: (1) an all-solid secondary battery, and (2) an electrolytic-solution secondary battery.

(1) A secondary battery comprises: the present solid electrolyte; and a positive electrode and a negative electrode, the positive electrode and negative electrode arranged at opposite facing positions interposing the solid electrolyte. The secondary battery is an all-solid secondary battery. The all-solid secondary battery has a large capacity. Moreover, since the all-solid secondary battery does not use any organic electrolytic solution, the all-solid secondary battery is of high safeness.

The positive electrode is composed of a positive-electrode material. The positive-electrode material is composed of a metallic plate made of copper, silver, gold, iron or nickel, and the like, for instance.

Moreover, a case, where the positive-electrode material is composed of an electrode active material for positive electrode, and a current collector covered with the electrode active material for positive electrode, is also available. As for the electrode active material for positive electrode, a metallic composite oxide of lithium and transition metal, such as a lithium-manganese composite oxide, a lithium-cobalt composite oxide or a lithium-nickel composite oxide, is used. To be concrete, the following are given: LiCoO₂, LiNi_{1/3}Co_{1/3} Mn_{1/3}O₂, LiNi_{0.5}Co_{0.2}Mn_{0.3}O₂, Li₂MnO₃, and the like. Moreover, for the electrode active material for positive electrode, a sulfur elementary substance, a sulfur-modified compound, oxygen, water, and so forth, are also usable. An allowable current collector for positive electrode is a current collector having been employed commonly for the positive electrode of a lithium-ion secondary battery, such as a current collector made of aluminum, nickel or a stainless steel. A permissible current collector for positive electrode has various configurations, such as meshes and metallic shapes.

The negative electrode is composed of a negative-electrode material. The negative-electrode material is composed of a metallic plate made of lithium, tin, magnesium, calcium, aluminum or indium, and the like, for instance. Moreover, a case, where the negative-electrode material is composed of an electrode active material for negative electrode, and a current collector covered with the electrode active material for negative electrode, is also available. The electrode active material for negative electrode is composed of: an elementary material composed of an element being able to sorb (or occlude) lithium ions therein and desorb (or release) lithium ions therefrom and being able to undergo an alloying reaction with lithium; or/and an elementary compound comprising an element being able to undergo an alloying reaction with lithium. Note that an allowable electrode active material for negative electrode also includes a carbonaceous material along with the elementary material or elementary compound. Alternatively, instead of the elementary material or elementary compound, a permissible electrode material for negative electrode even includes a carbonaceous material. An acceptable carbonaceous material serving as the electrode active material for positive electrode uses graphite, such as natural graphite and artificial graphite, or a carbon nanotube.

An allowable elementary material is a material composed of at least one member selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Even among the elements, a permissible elementary material is composed of silicon (Si), or tin (Sn). An allowable elementary compound is a compound comprising one of the materials. Even among the materials, a permissible elementary compound is a silicon compound, or a tin compound. An acceptable silicon compound is SiOₓ(where 0.5≦“x”≦1.5). As the tin compound, tin alloys, such as Cu—Sn alloys or Co—Sn alloys, and so on, are given.

Coating any of the electrode active materials for positive electrode and negative electrode onto a surface of the current collector is acceptable. However, coating any of the electrode active materials onto the porous portion of the solid electrolyte is more acceptable. The latter is more acceptable because the electrode active materials enter the porous portion and thereby a contact area between the solid electrolyte and the electrode active materials enlarges, and also because the electrode active materials are prevented from being come off from the solid electrolyte.

(2) Moreover, a secondary battery comprises: a separator composed of the present solid electrolyte; a positive electrode; a negative electrode; the positive electrode and negative electrode arranged at opposite facing positions interposing the separator; and an electrolytic solution filling up at least one of opposite sides interposing the separator, the opposite sides including a positive-electrode side on which the positive electrode is arranged, and a negative-electrode side on which the negative electrode is arranged. The secondary battery is an electrolytic-solution secondary battery. In the case of an electrolytic-solution secondary battery, a negative-electrode material used for the negative electrode is composed of a metallic plate, for instance. As for a material for the metallic plate serving as the negative-electrode material, metals, such as lithium (Li), sodium (Na), magnesium (Mg), calcium (Ca), aluminum (Al), potassium (K), strontium (Sr) and barium (Ba), or alloys of the metals, are usable, for instance. A positive-electrode material used for the positive electrode is composed of a metallic plate, for instance. For the metallic plate serving as the positive-electrode material, metals, such as copper, iron, nickel, silver and gold, or alloys of the metals, are usable, for instance.

Moreover, a case, where the negative-electrode material is composed of a current collector for negative electrode, and an electrode active material for negative electrode covering a surface of the current collector, is also available. In addition, another case, where the positive-electrode material is composed of a current collector for positive electrode, and an electrode active material for positive electrode covering a surface of the current collector, is even available. Under the circumstances, allowable electrode active materials for negative positive and positive electrode are also the negative-electrode and positive-electrode electrode active materials, which have been described in (1) itemized as above, respectively. Moreover, although coating the electrode active materials onto a surface of the current collector is permissible, coating the electrode active materials onto a surface of the porous portion of the solid electrolyte is more permissible.

The electrolytic solution fills up at least one of the positive-electrode side and negative-electrode side interposing the separator. A preferable electrolytic solution also fills up the positive-electrode side, a permissible electrolytic solution also fills up the negative-electrode side, and an acceptable electrolytic solution even fills up both of the positive-electrode side and negative-electrode side. As for an electrolytic solution for positive electrode and an electrolytic solution for negative electrode, any of organic electrolytic solutions and water-soluble or ionic-liquid electrolytic solutions is employable. Using any one of the electrolytic solutions is dependent on types of the positive-electrode material and negative-electrode material. An advisable electrolytic solution is an organic electrolytic solution, or an ionic liquid. The “organic electrolytic solution” refers to an electrolytic solution composed of an electrolyte and an organic solvent.

In (2) itemized as above, an allowable solid electrolyte serving as the separator comprises the porous portion having a surface making contact with the electrolytic solution. When an electrolytic solution for positive electrode and an electrolytic solution for negative electrode exist on both front and rear faces of the solid electrolyte, respectively, a permissible solid electrolyte comprises the porous portion on both of the front and rear faces. Since the porous portions have a large superficial area, the sorbing and desorbing of ions are carried out efficiently, thereby enabling an electrolytic-solution secondary battery to produce a high output.

Even in any of (1) and (2) itemized as above, when the positive electrode or/and the negative electrode comprises an electrode active material, an acceptable electrode active material for the positive electrode or/and the negative electrode fills up the interiors of pores in the porous portion of the solid electrolyte. Under the circumstances, a contact area between the electrode active material and the solid electrolyte augments, and thereby a contact resistance exerted between the electrode active material and the solid electrolyte is lowered. Moreover, since the electrode active material has entered the porous portion, the electrode active material hardly comes off from the solid electrolyte.

A configuration of the secondary battery is not limited especially at all, so that various configurations, such as cylindrical types, stack-layered types, coin types or laminated types, are adoptable.

An allowable vehicle has a secondary battery on-board. Driving a motor for traveling with the above-mentioned secondary battery results in enabling the motor to exhibit a large capacity and produce high outputs. A vehicle which makes use of electric energies produced by the secondary battery for all or some of the power source is acceptable, so electric vehicles, hybrid vehicles, and so on, are available, for instance. When a vehicle has the secondary battery on-board, the secondary battery is connected preferably in a quantity of multiple pieces in series to make an assembled battery. Other than the vehicles, the secondary battery is likewise applicable to all sorts of products given as follows: household electrical appliances, office instruments or industrial instruments, which are driven with batteries, such as personal computers or portable communication devices, and so forth.

### Embodiments

### First Embodiment

As illustrated in FIG. 1, a solid electrolyte 3 according to the present embodiment comprised a dense port ion 1, and a porous portion 2 formed on a superficial side of the solid electrolyte 3 so as to be continuous from one of the opposite surfaces of the dense portion 1. The dense portion 1 had a planar configuration. The dense portion 1 had a sintered density of 98%. The dense portion 1 had an open porosity of less than 1%. The dense portion 1 had a thickness of about 50 μm. A rate of the dense portion 1's thickness to the solid electrolyte 3's overall thickness was 25%.

The porous portion 2 had a porosity of 80%. Moreover, the porous portion 2 had an open porosity of 75%. Thus, a rate of the porous portion 2's open porosity to the porous portion 2's porosity was 94%. An average opening diameter “D” of open pores 20 opening in the porous portion 2's surface was 50 μm. An average depth “L” of the open pores 20 was 48 μm. The porous portion 2 had a thickness of about 100 μm. A rate of the porous portion 2's thickness to the dense portion 1's thickness was 2.

An oxide sintered body composing the solid electrolyte was a lithium-ion conductor. The dense portion 1 was garnet-type Li₇La₃Zr₂O₁₂ (or LLZ).

Upon producing the solid electrolyte, the dense portion 1 was first formed. In order to form the dense portion 1, a 1-μm-diameter powder of the solid electrolyte composed of LLZ was formed by a solid-phase method. Water was added to the resulting powder to turn the powder into a slurry, and the resultant slurry was molded as a sheet shape by a doctor-blade method. The thus molded body was dried, and was then sintered at 1,150° C.

Next, the porous portion 2 was formed onto a surface of the dense portion 1. In order to form the porous portion 2, a solid-electrolyte powder composed of the LLZ used in the dense portion 1 was admixed with water to turn the solid-electrolyte powder into a slurry. The resulting slurry was coated onto one of the opposite faces of the dense portion 1 to form a porous molded section. While maintaining the planar direction of the resultant porous molded section parallel to the horizontal direction, the porous molded section was freeze dried. A temperature during the freezing operation was set at −40° C. Liquid nitrogen was used to do cold trapping (or freeze capturing). The porous molded section was sintered at 1,100° C. after the freeze-drying operation.

### Second Embodiment

As illustrated in FIG. 2, in a solid electrolyte 3 according to the present embodiment, a porous portion 2 was formed on both of the front and rear faces of a dense portion 1. The dense portion 1 had a thickness of 50 μm. The porous portions 2 had a thickness of 100 μm, respectively. A rate of the dense portion 1's thickness to the solid electrolyte 3's overall thickness was 20%. After forming the dense portion 1, a slurry of the solid electrolyte was coated onto both of the front and rear faces of the dense portion 1, was freeze dried, and was then sintered. The other features were the same as the above-described features of First Embodiment.

### Third Embodiment

As illustrated in FIG. 3, in a solid electrolyte 3 according to the present embodiment, a porous portion 2's porosity had a gradient in the thickness-wise direction. The porous portion 2's porosity was 80% at a superficial-layer section 2a, and then became smaller gradually toward the interior, so that the porosity was virtually 0% at an interior section 2b adjacent to the dense portion 1 in the porous section 2. Upon forming the porous portion 2, a slurry of the solid electrolyte was coated onto a surface of the dense portion 1 in the same manner as illustrated in FIG. 1, was freeze dried, and was then sintered. The freeze-drying operation was done under such conditions that the resulting formed body was provided with a cooling medium at the top, and was then cooled by the cooling medium while giving the formed body a temperature gradient with the cooling medium. The other features were the same as the above-described features of First Embodiment.

### Fourth Embodiment

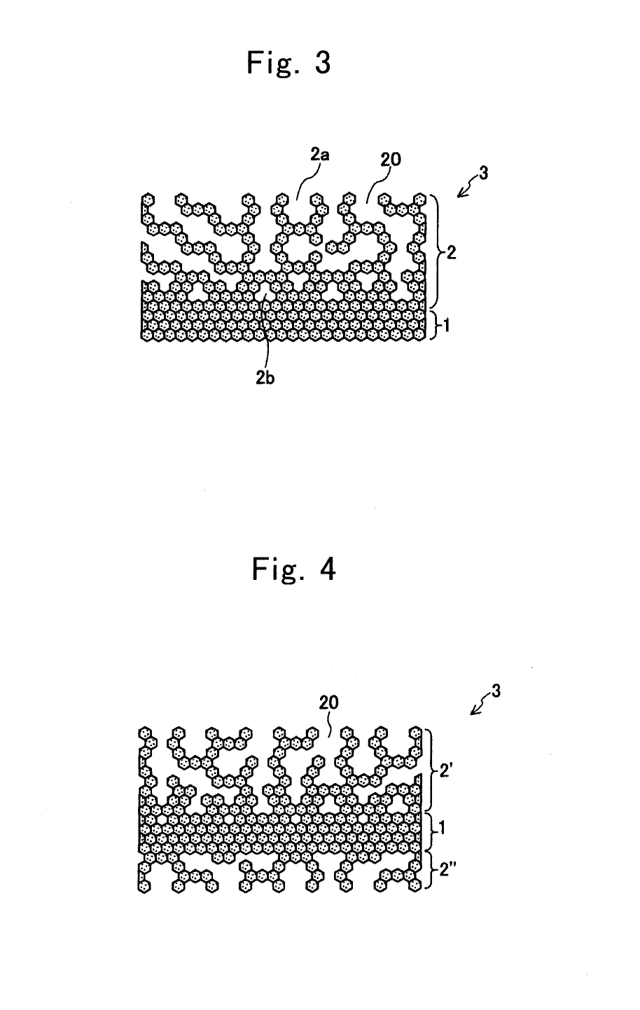

As illustrated in FIG. 4, in a solid electrolyte 3 according to the present embodiment, a porous portion 2′ formed on the front face of a dense portion 1 had a thickness of 100 μm. Moreover, another porous portion 2″ formed on the rear face of the dense portion 1 had a thickness of 50 μm. Thus, the thickness of the porous portion 2′ is larger than the thickness of the porous portion 2″. A thickness of the dense portion 1 was set at 50 μm. A rate of the dense portion 1's thickness to the solid electrolyte 3's overall thickness was 25%.

The porous portion 2′ with the larger thickness had a porosity which became larger on the superficial-layer section than on the interior section, in the same manner as the porous portion 2 according to Third Embodiment. The porous portion 2′ with the smaller thickness had a porosity which was virtually constant in the thickness-wise direction, in the same manner as the porous portion according to First Embodiment. The other features were the same as the above-described features of First Embodiment.

### Fifth Embodiment

As illustrated in FIG. 5, in a solid electrolyte 5 according to the present embodiment, a porous portion 2 was formed only on a surface of a dense portion 1. The porous portion 2 was made up of secondary particles 22 of the solid-electrolyte powder, and spaces 23 formed between the secondary particles 22. A diameter “M” of the secondary particles 22 was 10 μm. An average opening diameter “D” of the spaces 23 between the secondary particles 22 was 25 μm.

After forming the dense portion 1 in the same manner as described in First Embodiment, particles composed of LLZ was synthesized by a solid-phase method, and the resulting particles were then pulverized at a rate of 300 rpm using a ball mill, thereby forming the secondary particles 22 whose particle diameters were made uniform with each other substantially. Moreover, as an active-material powder for negative electrode, a 5-μm-diameter natural-graphite powder was readied. The secondary LLZ particles, and the natural-graphite powder were mixed one another in such amounts as making a volumetric ratio of 3:1, and then water was added to the resulting mixture to turn the mixture into a slurry. The resultant slurry was coated onto a surface of the dense portion 1, was dried, and was then calcined. Thus, the porous portion 2 was formed on a surface of the dense portion 1.

### Sixth Embodiment

As illustrated in FIG. 6, in a solid electrolyte according to the present embodiment, a dense portion 1 extended in the planar direction while repeating irregularities in a zigzagged manner in the thickness-wise direction of the solid electrolyte. On both of the front and rear faces of the dense portion 1, a porous portion 2 was formed. The porous portion 2 was formed not only on crests 1a in the front and rear faces of the dense portion 1, but also on roots 1c and inclinations 1b's forward faces therein. The porous portions 2 had irregularities on the surface along a configuration of the dense portion 1.

The dense portion 1 had a difference of 20 μm in height between the irregularities. The dense portion 1 had a thickness of 50 μm. The dense portion 1 exhibited a pitch of 25 μm between the irregularities. The dense portion 1 had a sintered density of 98%. The dense portion 1 had an open porosity of 1%. Note that the “open porosity” herein was a proportion of open pores which were present in the outermost surface of the irregular surface being formed by a die. The porous portions 2 had a porosity of 83%. The porous portions 2 had an open porosity of 80%. The porous portions 2 had a thickness of 100 μm, respectively.

In order to form the dense portion 1, a slurry of an LLZ powder was put between pressing dies having a zigzag-shaped surface to mold the slurry by pressuring, was dried, and was then sintered. The porous portions 2 were formed in the same manner as described in First Embodiment.

### Reference Example

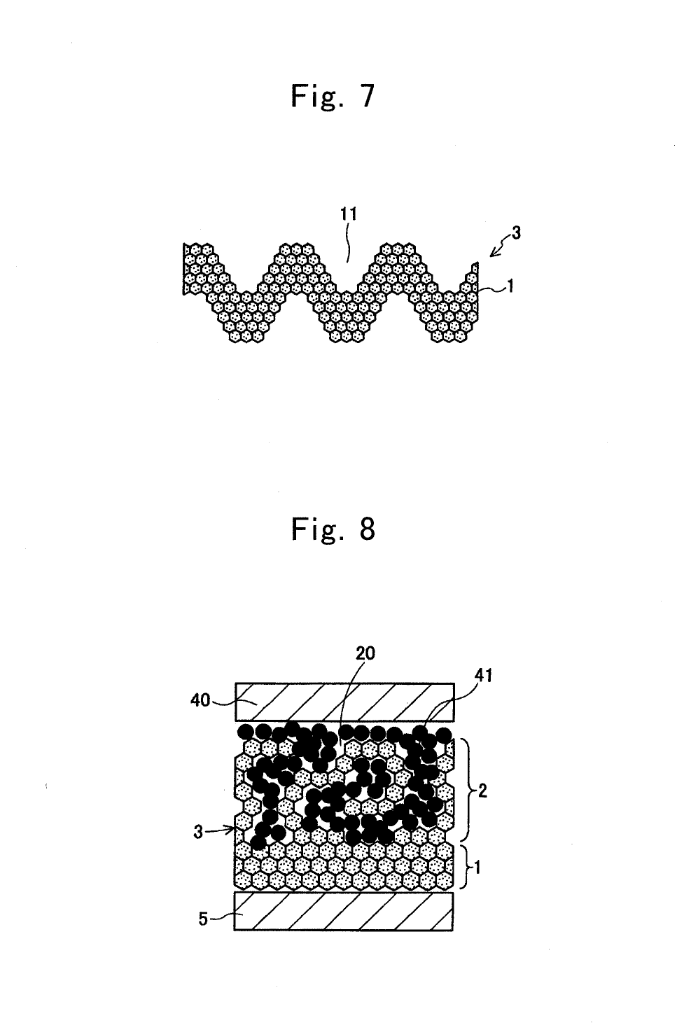

As illustrated in FIG. 7, a solid electrolyte 3 according to the present reference example was composed of a dense portion 1 alone in which irregularities were repeated in a zigzagged manner in the thickness-wise direction of the solid electrolyte. The irregularities of the dense portion 1 formed holes 11 between raised sections of the dense portion 1. Thus, the solid electrolyte 3 came to have an overall configuration making such a configuration in which the holes 11 are formed between the dense portion 1's raised sections.

The dense portion 1 had a difference of 20 μm in height between the irregularities. The dense portion 1 had a thickness of 50 μm. The dense portion 1 exhibited a pitch of 25 μm between the irregularities. The dense portion 1 had a sintered density of 98%. The dense portion 1 had an open porosity of 98%. The dense portion 1 was formed in the same manner as the dense portion 1 according to First Embodiment.

### Comparative Example

A solid electrolyte according to the present comparative example was composed of a plane-shaped dense portion alone. The solid electrolyte was constructed in the same manner as the dense portion according to First Embodiment. The solid electrolyte had a thickness of 50 μm.

### (First Battery)

An all-solid secondary battery was manufactured using the aforementioned solid electrolyte according to First Embodiment. As illustrated in FIG. 8, a slurry of an electrode active material 41 for positive electrode was applied onto a surface of the porous portion 2 of the aforementioned solid electrolyte 3 according First Embodiment by a doctor blade. The slurry of the electrode active material 41 for positive electrode included a 5-μm-diameter powder composed of LiCoO₂, a conductive additive, and a binder. The electrode active material 41 went into the open pores 20 in the porous portion 2, and was thereby prevented from being come off from the solid electrolyte 3. After the application operation, the electrode active material was dried, and was then sintered.

Next, a current collector 40 for positive electrode was put face-to-face to a surface of the porous portion 2 of the solid electrolyte 3. Moreover, a metallic plate 5 for negative electrode was put face-to-face to a surface of the dense portion 1 of the solid electrolyte 3. The current collector 40 for positive electrode was a metallic sputtered membrane composed of Pt, whereas the metallic plate 5 for negative electrode was composed of Li. The current collector 40, metallic plate 5 and solid electrolyte 3 were accommodated within a case, and were then sealed hermetically therein.

Since the solid electrolyte 3 according to First Embodiment was an oxide sintered body composed of LLZ, the solid electrolyte 3 was hard, compared with solid electrolytes composed of organic polymeric materials. Consequently, even when repetitive charging and discharging operations resulted in generating dendrites of lithium, the dendrites were prevented from penetrating through the solid electrolyte 3. Hence, there arose no fear of short-circuiting the battery. Since the oxide sintered body had high heat resistance, the oxide sintered body was less likely to burn, and was safe accordingly. Thus, the solid electrolyte 3 was employable even under severe environmental conditions.

Moreover, since the dense portion 1 had the very high sintered density, the dense portion 1 shut off the movements of substances other than lithium ions. Consequently, the battery was inhibited from short-circuiting. Moreover, since the porous portion 2 had the high porosity, the porous portion 2 had an enlarged superficial area, and thereby the sorbing and desorbing of lithium ions were carried out efficiently.

The porous portion 2 had the high porosity. Accordingly, ion-conductive paths became abundant. Moreover, the electrode active material 41 entered the porous portion 2. Consequently, a contact area between the solid electrolyte 3 and the electrode active material 41 was enlarged, and thereby a contact resistance exerted between the solid electrolyte 3 and the electrode active material 41 was reduced. Moreover, the electrode active material 41 was prevented from coming off from the solid electrolyte 3. Hence, the battery had an increased capacity.

### (First Comparative Battery)

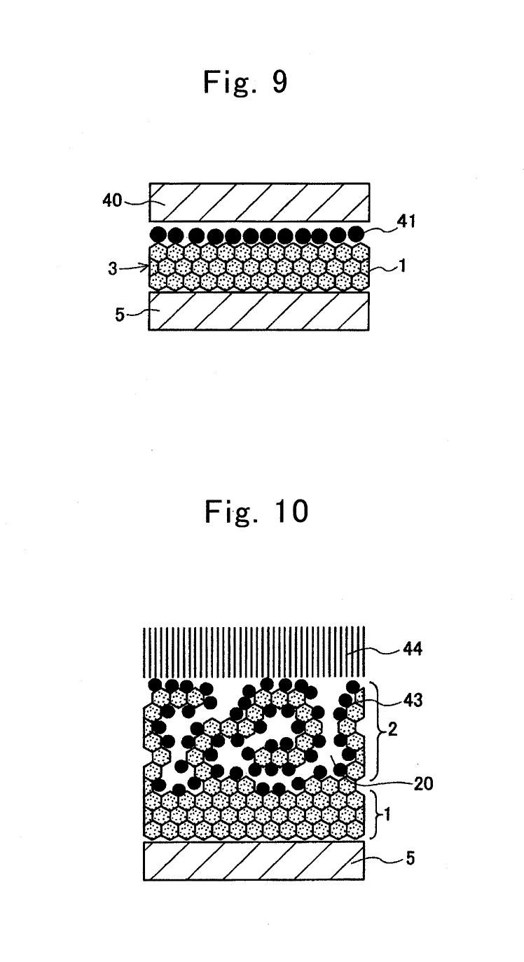

An all-solid secondary battery was manufactured using the solid electrolyte according to Comparative Example. As illustrated in FIG. 9, a slurry of an electrode active material 41 for positive electrode was coated onto one of the opposite faces of the solid electrolyte 3 by a doctor blade. Since the solid electrolyte 3 was composed of the plane-shaped dense portion 1 alone, the electrode active material 41 was applied onto one of the opposite faces of the solid electrolyte 3 lamellarly. Thereafter, a current collector 40 for positive electrode was arranged on the solid electrolyte 3 on one of the sides on which the electrode active material 41 was applied, whereas a metallic plate 5 for negative electrode was arranged thereon on the other side. The other features were the same as the above-described features of First Battery.

The solid electrolyte according to Comparative Example was constituted of the plane-shaped dense portion alone. Consequently, lithium-ion dendrites were prevented from penetrating through the solid electrolyte. However, since the solid electrolyte 3 was composed of the plane-shaped dense portion 1 alone, a contact area between the solid electrolyte 3 and the electrode active material 41 was small, and thereby the battery had a small capacity.

### (Second Battery)

The present battery was an electrolytic-solution secondary battery in which the solid electrolyte according to First Embodiment was used. In the present battery, positive-electrode-side electrolytic solution was added to the above-described constituent elements according to First Battery illustrated in FIG. 8. The positive-electrode-side electrolytic solution comprised an electrolyte composed of LiPF₆, and an EC/DEC solvent composed of EC and DEC which were mixed in such a ratio as EC:DEC=1:1 by volume. The positive-electrode-side electrolytic solution permeated the porous portion 2 of the solid electrolyte 3. In the porous portion 2 with the large porosity, the opportunity of contact between the sol id electrolyte and the electrolytic solution was abundant, and thereby the sorbing and desorbing of ions were carried out actively. Hence, the battery had a high output.

### (Second Comparative Battery)

The present comparative battery was an electrolytic-solution secondary battery in which the solid electrolyte according to Comparative Example was used as a separator. The battery according to the present comparative example further comprised an electrolytic solution added to the positive-electrode side, in addition to the constituent elements of First Comparative Battery illustrated in FIG. 9. The electrolytic solution was the same as the above-described electrolytic solution of Second Battery. In the present comparative battery, since the solid electrolyte was composed of the plane-shaped dense portion 1 alone, the solid electrolyte had a small superficial area compared with the solid electrolyte according to First Embodiment further comprising the porous portion, and thereby lithium ions were sorbed and desorbed less. Hence, the battery also outputted electricity less.

### (Third Battery)

An electrolyte secondary battery (e.g., an Li/Air battery) was manufactured using the solid electrolyte according to First Embodiment. As illustrated in FIG. 10, a metallic plate 5 composed of a lithium metal was arranged, as a negative electrode, onto a surface of the dense portion 1 of the solid electrolyte 3 according to First Embodiment. Onto a surface of the porous portion 2 of the solid electrolyte 3 according to First Embodiment, carbon nanotubes 43 were loaded as a positive-electrode active material, and a metallic plate 44 was further arranged as a current collector . In the present embodiment, the metallic plate 44 was a metallic mesh. The constituent elements were put in a case opened on the positive-electrode side, and were then sealed therein so as not to let Li touch the air.

In the present battery as well, since the solid electrolyte 3 was composed of the hard oxide sintered body, dendrites of lithium were prevented from penetrating through the solid electrolyte 3. Moreover, since the dense portion 1 had the very high sintered density, the dense portion 1 blocked the movements of substances other than lithium ions. Moreover, since the porous portion 2 had the high porosity, the porous portion 2 had a large reactive area. As a result, the performance was degraded less by the precipitation of Li₂O₂, namely, a reaction product, and thereby lithium ions were likely to be sorbed and desorbed. Moreover, lithium-ion conductive paths became abundant. Hence, the battery had an enlarged capacity, and thereby an intention to enable the battery to produce a high output was achieved.

### (Other Batteries)

Even when above-described First and Second Batteries were manufactured using the solid electrolytes according to Second through Sixth Embodiments, dendrites of lithium were inhibited from penetrating through the solid electrolytes in the same manner as described in First Embodiment, and the resulting batteries demonstrated a high capacity, respectively.

The solid electrolyte 3 according to Fifth Embodiment was produced by the above-described simple and easy method, and excelled also in the mass-producibility.

In the solid electrolyte 3 according to Sixth Embodiment, since the dense portion 1 took on the zigzag irregular configuration, ion-conductive paths were formed abundantly, compared with the dense portion 1 extending in a planar shape as the dense portion 1 extended in the other solid electrolytes. Hence, the proportions of active materials were enlarged within the battery construction, and thereby the resulting battery had a large capacity and demonstrated a high output.

When the porous portion 2 was formed only on one of the opposite faces of the dense portion 1 as done in First, Third and Fifth Embodiments, filling up the porous portion 2 with an electrode active material, or impregnating the porous portion 2 with an electrolytic solution, was allowable. Onto the other one of the opposite faces of the dense portion 1, placing a metallic plate serving as an electrode face-to-face was permissible. In particular, placing a lithium metal-including metallic plate, in which dendrites are likely to grow remarkably, in a face-to-face manner onto the other one of the opposite faces of the dense portion 1, was acceptable. Thus, the penetration of dendrites through the resulting solid electrolyte was shut off securely by the dense portion 1.

When the porous portion 2 was formed on both of the front and rear sides of the dense portion 1 as done in Second, Fourth and Sixth Embodiments, filling up the two opposite-side porous portions 2 with an electrode active material was allowable. Under the condition, the electrode active material entered pores formed in a large number in the porous portions 2, thereby not only reducing a contact resistance but also preventing the electrode active material from coming off. Moreover, when the porous portion 2 was formed on both of the front and rear sides of the dense portion as done in Second, Fourth and Sixth Embodiments, impregnating the porous portions 2, which were formed on both of the front and rear faces of the dense portion 1, with positive-electrode and negative-electrode electrolytic solutions, respectively, was permissible. Thus, the opportunity of contact between the electrolytic solutions and the resulting solid electrolyte augmented within the electrolytic solutions themselves, and thereby the sorbing and desorbing of ions were carried out actively. Consequently, the resultant battery had a high capacity, and thereby demonstrated a high output.

Moreover, the solid electrolyte according to Reference Example was formed of the dense portion alone in which the irregular configurations were repeated. Consequently, the solid electrolyte had an enlarged superficial area, and thereby ion-conductive paths increased. Hence, an intention to enable a battery to produce a high output was achieved. Moreover, since the solid electrolyte according to Reference Example was also composed of the oxide sintered body, dendrites of lithium were prevented from penetrating through the solid electrolyte.

Other batteries are also made by substituting sodium, magnesium, calcium or aluminum, and so on, for instance, for lithium used as the negative-electrode material for the above-described batteries.

### EXPLANATION ON REFERENCE NUMERALS

1: Dense Portion;
2: Porous Portion;
3: Solid Electrolyte;
4: Positive-electrode Metallic Plate;
5: Negative-electrode Metallic Plate;
10: Solid Section;
11: Pored Section;
20: Open Pore;
40 or 44; Current Collector for Positive Electrode;
41: Electrode Active Material for Positive Electrode; and
43: Carbon Nanotube (i.e., Electrode Active Material for Positive Electrode)

1. A solid electrolyte being a sheet-shaped solid electrolyte composed of an oxide sintered body, said solid electrolyte comprising:
a layer-shaped dense portion whose sintered density is 90% or more; and
a porous portion formed on a superficial side of said solid electrolyte so as to be continuous from at least one of opposite surfaces of said dense portion, and having a porosity of 50% or more, wherein
a porosity of a superficial-layer section of said porous portion is larger than a porosity of an interior section of said porous portion.

2. The solid electrolyte as set forth in claim 1, wherein an open porosity of said porous portion is 50% or more.

3. The solid electrolyte as set forth in claim 1, wherein an open porosity of said dense portion is 5% or less.

4. The solid electrolyte as set forth in claim 1, wherein a thickness of said dense portion is from 1 μm or more to 1,000 μm or less.

5. The solid electrolyte as set forth in claim 1, wherein a ratio of the thickness of said dense portion to an overall thickness of said solid electrolyte is from 5% or more to 95% or less.

6. The solid electrolyte as set forth in claim 1, wherein a thickness of said porous portion is from 0.1 μm or more to 500 μm or less.

7. The solid electrolyte as set forth in claim 1, wherein said oxide sintered body is a lithium-ion conductor.

8. The solid electrolyte as set forth in claim 1, wherein a crystal structure of said oxide sintered body belongs to a garnet type.

9. (canceled)

10. The solid electrolyte as set forth in claim 1, wherein said porous portion comprises an electrode active material and solid-electrolyte powdery particles dispersed among said electrode active material, and is formed by mixing said electrode active material and said solid-electrolyte powdery particles one another, coating the mixed electrode active material and solid-electrolyte powdery particles onto at least one of the opposite surfaces of said dense portion and then calcining the coated electrode active material and solid-electrolyte powdery particles.

11. The solid electrolyte as set forth in claim 1, wherein a cross section of said dense portion has a configuration in which irregularities are repeated.

12. (canceled)

13. A secondary battery comprising:
the solid electrolyte as set forth in claim 1;
a positive electrode; and
a negative electrode;
the positive electrode and negative electrode arranged at opposite facing positions interposing said solid electrolyte.

14. A secondary battery comprising:
a separator composed of the solid electrolyte as set forth in claim 1;
a positive electrode;
a negative electrode;
the positive electrode and negative electrode arranged at opposite facing positions interposing said separator; and
an electrolytic solution filling up at least one of opposite sides interposing said separator, the opposite sides including a positive-electrode side on which said positive electrode is arranged, and a negative-electrode side on which said negative electrode is arranged.

15. The secondary battery as set forth in claim 13, wherein said negative electrode is composed of a lithium metal.

16. The secondary battery as set forth in claim 13, wherein
at least one of said positive electrode and said negative electrode comprises an electrode active material,
said electrode active material goes into pores formed in said porous portion of said solid electrolyte.

17. A secondary battery comprising:
a separator composed of a solid electrolyte;
a positive electrode;
a negative electrode;
the positive electrode and negative electrode arranged at opposite facing positions interposing said separator; and
an electrolytic solution filling up at least one of opposite sides interposing said separator, the opposite sides including a positive-electrode side on which said positive electrode is arranged, and a negative-electrode side on which said negative electrode is arranged, wherein
said solid electrolyte is a sheet-shaped solid electrolyte composed of an oxide sintered body, said solid electrolyte comprising:
a layer-shaped dense portion whose sintered density is 90% or more; and
a porous portion formed on a superficial side of said solid electrolyte so as to be continuous from at least one of opposite surfaces of said dense portion, and having a porosity of 50% or more.

18. The secondary battery as set forth in claim 14, wherein said negative electrode is composed of a lithium metal.

19. The secondary battery as set forth in claim 18, wherein
at least one of said positive electrode and said negative electrode comprises an electrode active material,
said electrode active material goes into pores formed in said porous portion of said solid electrolyte.
